(19) United States
(12) Patent Application Publication
(10) Pub. No.: US 2009/0272252 A1
(43) Pub. Date: Nov. 5, 2009

(54) METHOD FOR COMPOSING A PIECE OF MUSIC BY A NON-MUSICIAN

(75) Inventor: Jacques Ladyjensky, Brussels (BE)

Correspondence Address: YOUNG & THOMPSON, 209 Madison Street, Suite 500, ALEXANDRIA, VA, 22314, US

(73) Assignee: CONTINENTAL STRUCTURES SPRL, BRUSSELS (BE)

(21) Appl. No.: 12/093,608

(22) PCT Filed: Nov. 14, 2006
(86) PCT No.: PCT/BE2006/000123

§ 371 Date: Jan. 5, 2009

(30) Foreign Application Priority Data
Nov. 14, 2005 (BE) 2005/0550

(51) Int. Cl. G10H 1/36

(52) U.S. Cl. 84/610

(57) ABSTRACT

A method for composing music by a non-musician is based on the use of pre-recorded melodies which are stored in banks and associated with orchestra accompaniments also stored in banks. The orchestra accompaniments are in advance embodied in the form of an entire devoid of melody part. A selected melody is associable, with the aid of a suitable software, with a selected accompaniment by a dictation process which makes it possible to select, with a tolerance range, the duration and position of each melody note in the accompaniment.

The present method is aimed to persons who, despite being strongly attracted by music, and particularly by musical composition, are not gifted for practising a musical keyboard, nor for receiving any teaching in musical branches such as solfeggio or harmony.

The pieces of music for which the present method is appropriate are those—as is frequently the case—consisting in a melody plus an accompaniment. The accompaniment is often called orchestration, or orchestral accompaniment, when it involves several instruments.

To emit a melody, the simplest method for the concerned person, who is unable to actually compose it, is to take such a melody among those existing in the musical repertory of the past (this is not unlawful if the author is deceased for more than 70 years) and to copy it, with or without slight adaptations, as for instance removing an obsolete ornamental feature, or, more generally, with or without reworking of it.

This being done, said person will be able to sing it mentally, —for want of writing it.

One first—although slight—handicap, will be his incompetence for registering it.

But he will face much stronger handicaps, when composing an accompaniment or orchestration which has to go along with his melody. This is due to his ignorance in solfeggio, harmony, and keyboard practising. Until now, he would have to put it into the hands of a competent arranger, —from where, serious inconveniences will occur in matter of delivery time, of cost, and of paternity sharing. The handicap in matter of delivery time is not to be underestimated, because it is frequent that a musical piece, a song for instance, has to be composed rapidly, because, for example the demand and/or the inspiration is momentary. Some computerized <<automatic arrangers>> do exist, to which the melody can be committed in order to obtain a finished piece of music, but their operation requires imperatively to be a musician, —and that is not the case of the users according to the invention.

The method according to the present invention, which uses the known tools of computership, allows to obtain within a short time a musical work, novel and original, with length of an entire piece of music, for instance that can afford within the same day a piece of several minutes.

It consists in using melody banks and accompaniment banks, these latter being collections of orchestral accompaniments. These have the length of an entire piece of music. Such a structure of accompaniment <<canvas>> involves several accompaniment instruments, with a rhythmic preferentially associated to those of our times, an introduction and a final.

These collections of orchestral accompaniment canvas are presented in several collections, for instance collection a, collection b, collection c, etc., each of them sounding in a distinct tonality. They are recorded in advance in the software put at disposal of the user, in a way that also allows him to audibly hear them.

The melody banks which are in the same way at disposal of said user, are grouped together in collections sounding each in a distinct tonality, —one may name them collection A, collection B, collection C, etc. These melodies are either original and free of rights, or—and this is generally the case—part of the musical patrimony fallen in public domain. Of course they also may be a reproduction authorised on behalf of the composer.

The user is invited to hear these melodies and these orchestral accompaniments, to deeply examine those having his preference, and to do a choice. He has, obligatorily—under penalty of further discords at final audition—to associate a melody, of collection <<A>> for instance, to an homonymous accompaniment, i.e. here from collection <<a>> with same example. The method allows then the association and simultaneous recording by the user of the two chosen components i.e. a melody and an accompaniment, —this, according to the following operations, done with the help of the software he has at disposal.

First, he has to mentally be in possession, by listening to, and <<impregnating>> of the melodic theme, selected in one of the banks, theme which is presented to him under audible way by means of sounding notes heard one after the other in sequence. He has to inscribe these notes on the screen, one after the other, by intuitively selecting them from a small virtual keyboard appearing in the screen. The thing is easy to do, just with the ear, with the possibility of modifying the chosen note if he judges that it does not sound agreeably and suitable to his ear. It is not at all necessary that the user be able to identify—in the musical sense—what kind of note he is typing. Anyway it is also not necessary that the typed signs that he makes appear on the screen for recording them in the form of his melody, be musical notes in their conventional design. If they resemble musical notes, they bear anyway no indication of duration like <<round>>, <<half-note>>, <<quaver>>, etc. To have them sound, the user has to touch them on the screen with the arrow cursor (mouse cursor), and the longer time he touches, the longer will the note sound. So he obtains a control on the melodic theme he is recording, with possibility of modifying it according to his taste and inspiration, by suppressing or adding some notes. If he judges the melodic theme too short, he can repeat it, or add another one extracted from the same bank. This can be particularly interesting if he wishes to have <<refrains>> alternating with <<stanzas>>.

Then he has to do a choice, in the homonymous bank, of an orchestral accompaniment.

He let it play audibly, then comes back to his melody, of which he touches the notes in sequence, according to respective durations he judges good, and this in a rhythm that he judges appropriate to the one of the accompaniment. Said accompaniment is heard simultaneously with his playing the melody.

At this moment he is still allowed to bring to the melody the modifications he would wish, then to re-listen it again, with accompaniment playing simultaneously.

The next step will be to record simultaneously the melody sound and the one of the orchestral accompaniment, —but not <<no matter how>>. The process allows the user to really <<adapt>> his melody in function of the heard accompaniment. To that end, the software puts at disposal the following manoeuvre. He launches the accompaniment sound, and acts on the mouse in a way that, for each mouse click, one melody note registers, and this audibly, and in sequence, beginning with the first note, with as feature that each of these successive melody sounds is recorded by the system as being of the duration of the click pushed by the user. Said user masters then finely the final structure of the piece, since he decided himself, note after note, how the note will have its position materialized towards the accompaniment sounds, and what will be the individual durations he has given to each one of the <<dictated>> notes.

Once the piece is recorded, it comes visible on the screen as a linear schematic representation in form of a ribbon provided with time units, equal and numbered as sequences (the <<bars>>) with a cursor moving together with the march of the heard music. This allows the user to improve again his work, in the following way. By the hearing, he notes or marks the bar number where he could have heard two incompatible notes, —or that he estimates such. (One note of the melody not sounding harmoniously, for him, with a note of the accompaniment.) For one of the two—and that will generally be the one belonging to the accompaniment—he has the wish to suppress it, or soften it. With this aim the software allows him to do appear on the screen the accompaniment structure, at the level of the concerned bar. The intervening instruments do appear, each one with a virtual potentiometer ruling its volume. He just has to soften the one concerned, and this only for the duration of the concerned bar, excluding the other bars.

On the market are existing other softwares which present functions that could be considered as presenting some analogy with the present ones. To be cited particularly <<E-Jay>>, which allows the juxtaposition of a melody, selected from one bank, to an accompaniment, selected from another bank. Compared with the present invention, there are some notable differences. For the melodies that it offers, and which, right from the start, have an imposed rhythmic, the same as for the accompaniment, it is not allowed, at the moment of association (which is in no way a dictation note by note) to modify the note nature or the note duration, or the note position towards accompaniment.

The associated figures allow a better understanding of the invention and in particular of the example which follows.

FIG. 1 represents an example of what appears on the computer screen when the user calls for a melodic theme from one of the banks, melodic theme here composed of 2 phrases of each 7 notes, and represented on the screen by 14 marks 2 disposed in sequence on a staff 1.

FIG. 2 represents the same sequence modified by the user in order to better adapt to his taste the notes of the called melody.

FIG. 3 shows an example of the screen representation of the way for the evolution of march of the orchestral accompaniment. The cursor 4, vertical slash, is represented on it. It is mobile since the departure and moves at uniform speed, in proportion as the march of accompaniment is audibly playing, over 32 zones 3, successive, equal, that may be named bars, and numbered in sequence. The user, listening to the accompaniment playing, may at any moment identify, by its number, on which bar the sounding play is arrived.

FIG. 4 represents the same thing with the cursor 4 in position of rest, before the departure of the march of play of orchestral accompaniment.

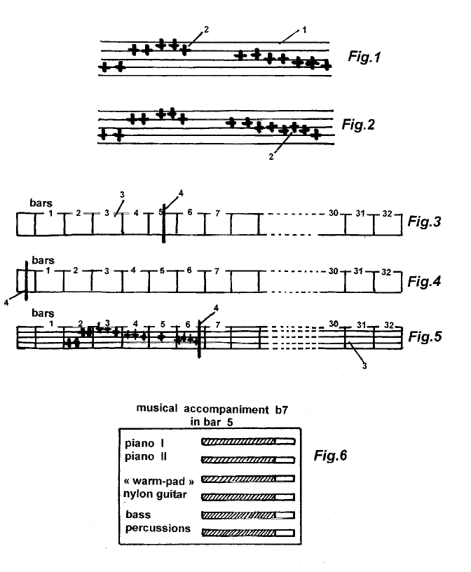

FIG. 5 represents again the cursor in course of travel, here arrived in bar 6. The preceding bars have been successively provided of marks which materialize the fact that the notes of the melody have been dictated, inscribed and recorded over those of the orchestral accompaniment.

FIG. 6 shows an example of screen representation of the structure of an orchestral accompaniment corresponding to a given bar.

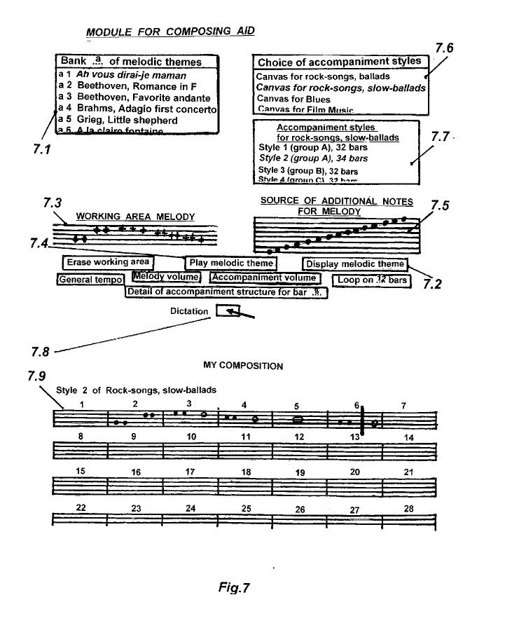

FIG. 7 represents schematically a <<screen capture>> deemed to represent the possibilities of manoeuvre by the user, with his mouse, in the course of the principal operations of composing aid.

The following example illustrates by an actual case the description of the method according to the invention.

The user begins with exploring, by audition, the melody banks annexed to the software. They are classified in categories like: cheerful, serious, nostalgic, sad, or others. At this stage the tempo, or play speed for the melody, is not yet decided by the user. He will do it later. When choosing a melody, he notes to which collection it belongs: say, for instance, collection A. At the appropriate moment he will have to choose an accompaniment in the homonymous collection.

In plus of sound-listening, the user may, and should, let appear on screen a schematic representation of the sound sequence of the chosen melodic theme. Let us suppose that he chose a melody, sprung from the folkloric patrimony, of title <<Ah vous dirai-je maman>>. By a manoeuvre of banal type, he lets appear a sequence of marks 1 on a staff 2 (FIG. 1) which represents the sequence of the fourteen concerned sounds (two series of seven). The software allows him, when he touches one of these marks with the arrow-cursor, to hear it sounding. One may, if one likes it, call these marks, music notes, although it is not necessary that said marks show the note height or the note duration. In this example, one can see that the heights are shown but not the durations. With simple manoeuvres the user can transfer these notes one by one in a screen window named <<working area>>, where he may, if desired, rework this melody. A button is at disposal to erase any undesirable <<note>>, and, in order to add some other more, he may use a small virtual keyboard situated on the screen. Sure being non-musician, he is not deemed to be able to identify the notes he is typing, but intuitively, by successive trials, he may without problem go through. Let us suppose for instance that he adds one more <<note>>: that gives on the screen the schematic representation of FIG. 2.

His melody, being considered as approved in what concerns the choice of sounds (but not yet their durations nor the rhythm of play), he leaves it on the screen, and goes explore, audibly, the orchestral accompaniments in the banks which contain them, and, here, more precisely, in the homonymous bank, <<collection a>>. He chooses one, taking into account the melody he has in head, according to his taste. The bank allows him to choose among various styles, and let us presume for instance that he chooses an accompaniment in the style <<rock-songs>>. By means of a simple manoeuvre, he registers it with screen materialization of its visual schematic representation for movement, FIG. 3.

The cursor, when launched, describes the ribbon entirely until the last bar, the one bearing the number 32, and the sound goes with, audibly, so that the user has a marking system. In the here chosen case, <<rock-songs>>, the orchestral accompaniments are built with a length of 25 to 35 bars. In the software are at disposal simple tools allowing to suppress certain bars, or to double some, or changing places some bars, doubled or not, and other manoeuvres of that kind. The user has also to assign a tempo, a play speed, for the movement of its orchestral accompaniment. Frequently he will decide to let the melody play (this is the purpose of a manoeuvre which will be described hereunder) only after one or several bars of accompaniment alone. The same at the end of the piece. In prevision of this, between other reasons, the accompaniments have been composed with an introduction part, and a final part. In our example, as it goes with a song, the whole has a duration of two minutes.

The user should now, in his way, <<dictate>> his melody on his orchestral accompaniment. For this purpose he launches on the screen a manoeuvre called <<rhythmic dictation>>. The software puts then the cursor of the accompaniment ribbon in its departure position (FIG. 4) and a white square gets installed on the screen, in which the user is invited to come pointing his arrow-cursor (mouse cursor). By clicking, the first note of the melody comes register in superposition of the accompaniment, and this, at the moment exactly decided by the user for his clicking, when, after having started the accompaniment, he follows attentively its marching movement on the screen as well as its simultaneous auditive march. He may begin at bar 2 leaving then the accompaniment playing alone during the first bar. At each clicking, one more note will come and register. If he pushes a longer click, the concerned note will be longer in duration. Helped by the fact that the accompaniment marches together with his manoeuvre with the melody, the user, and the user only, will give the rhythm, judged appropriate, to the piece, since he masters at the same time the very moment where he inscribes a note and the duration he is giving to it.

FIG. 5 shows the cursor in course of march, arrived on the sixth bar. When looking attentively to this figure, one may see that the user has slightly modified the rhythm evoked by the former sequences (FIG. 1, FIG. 2). He has, if one can use such a term, <<swung>> in comparison with the steady rhythm generally met in folkloric melodies. Bar 5 has only one note, because he pushed a long click. And on bar 6 he clicked four times, and rapidly.

Once this dictation done, the piece is recorded <<melody plus accompaniment>>. He may re-listen to it, then do again the manoeuvres, improving them as many times he wishes. To be noted that, at no moment, he needed to know what are the <<music notes of solfeggio>>, the staffs, and even also the bars in the theoretical sense of the term. Sure the marks which appear on the screen can have the shape of music notes, but the thing is not mandatory, since they are only marks with aim to help for manoeuvres done essentially while listening.

Now it can happen that when listening to the piece, the user or his relations do observe that there is some discordance between a note of the melody and a sound played simultaneously by the accompaniment. The origin of this situation is in the fact that, in contrast to the usual practice, there has been no intervention of a human or an automatic arranger who could have taken into consideration the melody in order to arrange the orchestral accompaniment. This one was preexisting. Sure it had been composed in the same tonality (here collection a) than this of the melody (collection A) but, in matter of music, some surprises are possible. Furthermore the user has had the faculty to modify the proposed melody, and he could have been abusing of said faculty. (By the way, it is still time for him to do a comeback on this point.)

The correcting manoeuvre allowed by the present process consists in noting the number of the concerned bar, and, by a simple manoeuvre, in letting appear on the screen the structure of the orchestral accompaniment at the level of said bar. FIG. 6 shows in a schematic way, how such a table of structure appears for the considered bar, —here the one bearing for instance the number 7. Every instrument of the orchestral accompaniment appears on the screen with a small virtual potentiometer, which, activated, allows to soften or suppress the considered instrument sound. For the user, it will be enough, by means of an attentive listening, to identify which one of the instruments is responsible of the dissonance. Generally it will be one of the soloist instruments of the accompaniment, and in no case, for evident reasons, one of the percussions, to be left as they are.

To summarize the course of manoeuvres to be done by the user in order to compose a music piece, one may examine the FIG. 7. In this example is considered the music of a <<rock-song>>, including the accompaniment. The user begins, with the scrolling menu 7.1 to select a group of melodies, here the collection a, then a melody title, here <<ah vous dirai-je maman>> that he lets appear in overbrightness or augmentative way. He then pushes on the buttons 7.2 and 7.4 and the melody will come displayed along 7.3 at the same time as it is heard, played by the machine. Using 7.5 he may let some additional <<notes>> glide until the working zone 7.3. He may also erase some, thanks to the erasing key of the computer keyboard. The <<notes>> are represented with their audible <<height>> but not with their individual duration indicated. With the scrolling-menus 7.6 and 7.7 the user will choose, first a group of styles, —here <<Canvas for rock-songs, slow-ballads>>, then a style, —here the style 2, of which he has taken care to verify that it is a group A style, thus compatible with a homonymous melody. He lets glide the selected line on the virgin staffs of the score entitled <<My Composition>> at the screen bottom, in 7.9, where appears then the title of the selected accompaniment. This latter is to listen via a start manoeuvre (here the space-bar of the computer keyboard) and, as the accompaniment sound is emitted, the cursor here seen on the bar 6, moves in concordance, describing the numbered bars in sequence. At this point there are still no notes in said score bars, —the accompaniment plays alone, to allow the user to become familiar with. The next step is the one of the dictation, with use of the zone 7.8. By pushing on the button <<Dictation>> one starts the scroll-march audible and visible of the accompaniment, then with clicking with the mouse-cursor inside the white square, one note will be dictated in <<overprinting>> on the accompaniment. Every individual duration of note may be chosen, this in proportion of the clicking duration. Also the moment when a note is deposited is freely chosen. The result is a rhythm well appropriated to the desire or rather to the intuition of the user. In practice, he will be playing his <<dictation>> all the way intuitively, starting from the musical piece he had mentally in head. To be noted that the melody notes, dictated, and recorded in <<overprinting>> on the accompaniment, become visibly inscribed inside the numbered bars of the staffs. In the variant here illustrated, the machine writes in the traditional way the values of duration (round, half-note, quaver, etc.) the duration values intuitively dictated. The melody can then if desired, be printed and become readable by third parties.

1. A method for aiding composition of a piece of music, using a computer, said computer comprising at least
(a) a piece of software
(b) in memory, a plurality of collections of melodic themes, pre-recorded in audible mode (collection A, collection B, collection C, etc.)
c) in memory, a plurality of collections of orchestral accompaniments composed in advance and prerecorded in audible mode (collection a, collection b, collection c, etc.), each musical accompaniment forming the canvas of a future piece of music, but not having a main melodic theme,
the collection A, B, C, etc. each having been composed as distinct tonalities, with tonality in collection A the same as the one in collection a, tonality in collection B the same as in collection b, etc.,
wherein there is successively performed the following operations:
selecting a melodic theme from one of the collections, listening to it, displaying it on the computer's screen in the form of an audio and visual sequence made up of notes, which sequence appears in the form of marks, said marks having or not the look of notes of printed music, said marks having the role of marking signs with the aim of relistening and giving the possibility of adding or subtracting marks, possibly by moving backward, the software having been programmed so that upon every manoeuvre to add a mark an audible sound is emitted and recorded at the same time as said mark appears, each note being recorded according to its musical pitch but not necessarily according to its audible duration,
possibly bringing other modifications to the melody, on the basis of the hereabove described manoeuvres, taking account that to hear a note sounding, it suffices to touch with the arrow-cursor the mark which represents it,
choosing an orchestral accompaniment from one of the collections, taking care that the choice is given on an accompaniment of the tonality compatible with the one of the melodic theme,
successively dictating each of the sounds of the melodic theme, by superimposing them over the sounds of the orchestral accompaniment, that is let audibly scroll-marching, the dictation consisting in calling, by clicking, in sequence, each one of the abovementioned marks, with its associated sound, taking care to call and click every time the note at the correct moment towards the accompaniment rhythm, said correct moment being evaluated as <<correct>> by the user in full liberty, each note called, furthermore, being recorded in the system, together with the accompaniment, and being audible and adjustable in duration during the call procedure,
the entire dictation appearing on the screen, in a schematic way in the form of a numbered tape with equal segments, representing musical bars, in which the marks which represent the notes of the dictated melody are written in said segments.

2. Method for musical composition according to claim 1, wherein
there is traced on the screen, with use of the signs marking the melody notes on the tape figuring the numbered scrolling of the accompaniment, the place or places where a sound of the melody could, when listening, appear in discordance with one sound of the accompaniment, then, thanks to said tracing, to make appear on the screen what is the accompaniment structure at said place, i.e. the enumeration of the concerned accompaniment instruments for the concerned place, and to enable a manoeuvre of softening or suppressing of the one of the accompaniment instruments which is considered as unpleasant at this place, and only at this place.

3. A computer readable medium having stored thereon instructions that can be executed by a computer to perform the composition process according to claim 1.

4. A system comprising the medium of claim 3, a device capable of executing the instructions on such medium, and a device storing the collections of melodies and accompaniments.

5. Device for aiding composition of a piece of music, comprising a computer, said computer comprising at least
(a) a piece of software
(b) a memory comprising on the one hand several collections of melodic themes, pre-recorded in audible mode (collection A, collection B, collection C, etc.) and on the other hand,
(c) a plurality of collections of orchestral accompaniments composed in advance and pre-recorded in audible mode (collection a, collection b, collection c, etc.) each accompaniment forming the canvas of a future piece of music but without a main melodic theme,
the collections A, B, C, etc. having been each composed in distinct tonalities, with the tonality of collection A the same as for collection a, the one of collection B the same as for collection b, etc.,
in which the software comprises means for associating a selected melody to a selected accompaniment in merging them into a piece of recordable music and one which can be modifiable at will,
means being provided by the piece of software, via a graphical interface, for adding or subtracting notes, or modifying their characteristics or position.

6. A computer readable medium having stored thereon instructions that can be executed by a computer to perform the composition process according to claim 2.
